(19) United States
(12) Patent Application Publication
(10) Pub. No.: US 2019/0287041 A1
(43) Pub. Date: Sep. 19, 2019

(54) COLLABORATION PLATFORM WITH SKILLS GAP ANALYSIS

(71) Applicant: International Business Machines Corporation, Armonk, NY (US)

(72) Inventors: Thembani Togwe, Lenexa, KS (US); Michael J. Whitney, Cary, NC (US)

(21) Appl. No.: 15/922,252

(22) Filed: Mar. 15, 2018

(51) Int. Cl. G06Q 10/06; G06Q 10/10; H04L 12/18; G10L 15/18

(52) U.S. Cl. CPC G06Q 10/063112; G10L 15/1822; H04L 12/1822; G06Q 10/103

(57) ABSTRACT

Embodiments include methods, systems and computer program products method for managing a collaboration session. The computer-implemented method includes creating, using a processor, a collaboration session. The processor determines skills associated with one or more participants of the collaboration session. The processor further monitors one or more discussions within the collaboration session. The processor determines a skills gap by comparing the skills associated with one or more participants and skills determined in response to the monitoring of the one or more discussions. The processor further searches for one or more individuals having at least one skill associated with the skills gap. The processor further invites the one or more individuals to join the collaboration session.

### BACKGROUND

The present invention relates in general to user collaborations and more specifically, to virtual collaborations and the skills of attendees of virtual collaborations.

Collaboration platforms generally refer to a system that combines tools and processes to ensure that users can connect, collaborate and exchange information with other users, as well as sharing resources needed for collaboration for a given period of time.

Collaboration tools can be web-based applications that offer the users basic services such as instant messaging for groups, mechanisms for file sharing and collaborative search engines (CSE) to find information distributed within systems associated with an organization, community, or team. Additionally, the functionality can also include project management tools, integrated online calendars, shared online-whiteboards to organize tasks and ideas or internet teleconferencing integrations.

### SUMMARY

Embodiments of the invention are directed to a method for managing a collaboration session. A non-limiting example of the computer-implemented method includes creating, using a processor, a collaboration session. The processor determines skills associated with one or more participants of the collaboration session. The processor further monitors one or more discussions within the collaboration session. The processor determines a skills gap by comparing the skills associated with one or more participants and skills determined in response to the monitoring of the one or more discussions. The processor further searches for one or more individuals having at least one skill associated with the skills gap. The processor further invites the one or more individuals to join the collaboration session.

Embodiments of the invention are directed to a computer program product that can include a storage medium readable by a processing circuit that can store instructions for execution by the processing circuit for performing a method for managing a collaboration session. The method includes creating a collaboration session. The processor determines skills associated with one or more participants of the collaboration session. The processor further monitors one or more discussions within the collaboration session. The processor determines a skills gap by comparing the skills associated with one or more participants and skills determined in response to the monitoring of the one or more discussions. The processor further searches for one or more individuals having at least one skill associated with the skills gap. The processor further invites the one or more individuals to join the collaboration session.

Embodiments of the invention are directed to a system. The system can include a processor in communication with one or more types of memory. The processor can be configured to create a collaboration session. The processor can be configured to determine skills associated with one or more participants of the collaboration session. The processor can be configured to monitor one or more discussions within the collaboration session. The processor can be configured to determine a skills gap by comparing the skills associated with one or more participants and skills determined in response to the monitoring of the one or more discussions. The processor can be configured to search for one or more individuals having at least one skill associated with the skills gap. The processor can be configured to invite the one or more individuals to join the collaboration session.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The forgoing and other features, and advantages of the disclosure are apparent from the following detailed description taken in conjunction with the accompanying drawings in which:

FIG. 1 depicts a cloud computing environment according to one or more embodiments of the present invention;

FIG. 2 depicts abstraction model layers according to one or more embodiments of the present invention;

FIG. 3 is a block diagram illustrating one example of a processing system for practice of the teachings herein;

FIG. 4 is a block diagram illustrating a computing system according to one or more embodiments of the present invention;

FIGS. 5A-5C illustrate an exemplary collaboration session according to one or more embodiments of the present invention; and

FIG. 6 is a flow diagram of a method for managing a collaboration session according to one or more embodiments of the present invention.

The diagrams depicted herein are illustrative. There can be many variations to the diagram or the operations described therein without departing from the spirit of the invention. For instance, the actions can be performed in a differing order or actions can be added, deleted, or modified. In addition, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments of the invention, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

Turning now to an overview of technologies that are more specifically relevant to aspects of the invention, embodiments of the invention are related in general to collaboration platform management of collaboration sessions. Often during a collaboration session, it is ideal to know the skills that are required to address topics and tasks being discussed and to be able to assemble individuals having the skills needed to address the discussed topics and tasks efficiently. In today's environment, people are invited to participate in collaboration sessions (virtual collaborations) based on the skills known to be associated with each person generally. Unfortunately, people may have other skills that are not common knowledge. Often in the course of a collaboration with an already formed team, the need for a specific skill or skills not possessed by the current team members can arise. Typically, a skills deficiency can cause some delays because the team will need to find other individuals with the requisite skills to render assistance in the collaboration session. Current approaches may involve calling or instant messaging a number of different people to ask if they have the needed skill until you reach someone who has the required skill and is also available to participate in the collaboration session, which is time consuming and inefficient.

Turning now to an overview of the aspects of the invention, one or more embodiments of the invention address the above-described shortcomings of the prior art by identifying skills that are needed by a team for some specific activity but not possessed by the team. The skills of the current team can be determined and compared to skills needed to complete the activity. Those skills needed but not possessed by the team skills are associated with a skills gap. Users of a collaboration platform with at least one of the skills associated with the skills gap that are not a part of the team can be identified and can be invited to join the team by the collaboration platform.

The above-described aspects of the invention address the shortcomings of the prior art by actively and persistently monitoring discussions in a collaboration session to determine a skills gap and finding individuals to address the skills associated with the skills gap that are not currently a part of the collaboration session. The invention can also invite the individuals found to join the collaboration session.

It is understood in advance that although this disclosure includes a detailed description on cloud computing, implementation of the teachings recited herein are not limited to a cloud-computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud-computing environment is service oriented with a focus on statelessness, low coupling, modularity, and semantic interoperability. At the heart of cloud computing is an infrastructure comprising a network of interconnected nodes.

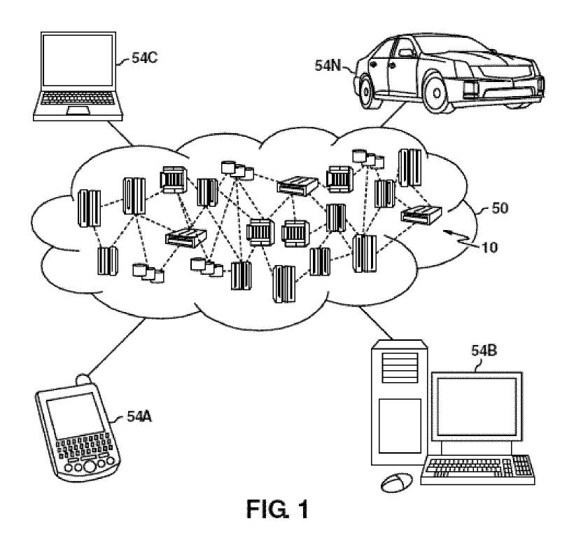

Referring now to FIG. 1, illustrative cloud computing environment 50 is depicted. As shown, cloud-computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud-computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

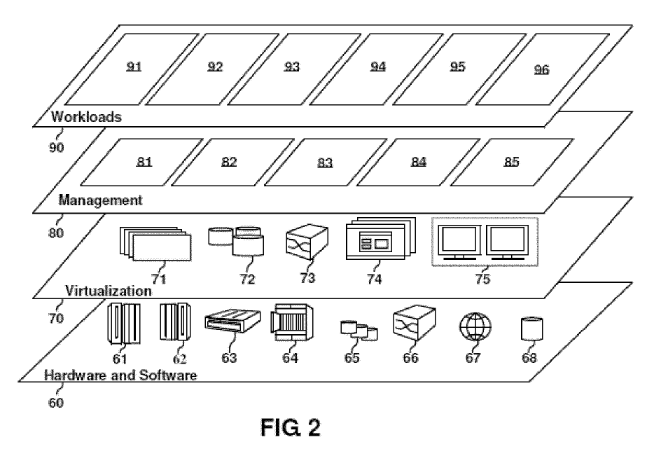

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided.

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud-computing environment. Metering and Pricing 82 provide cost tracking as resources are utilized within the cloud-computing environment, and billing or invoicing for consumption of these resources. In one example, these resources may comprise application software licenses. Security provides identity verification for cloud consumers and tasks, as well as protection for data and other resources. User portal 83 provides access to the cloud-computing environment for consumers and system administrators. Service level management 84 provides cloud computing resource allocation and management such that required service levels are met. Service Level Agreement (SLA) planning and fulfillment 85 provides pre-arrangement for, and procurement of, cloud computing resources for which a future requirement is anticipated in accordance with an SLA.

Workloads layer 90 provides examples of functionality for which the cloud-computing environment may be utilized. Examples of workloads and functions that may be provided from this layer include: mapping and navigation 91; software development and lifecycle management 92; virtual classroom education delivery 93; data analytics processing 94; transaction processing 95; and collaboration session management 96.

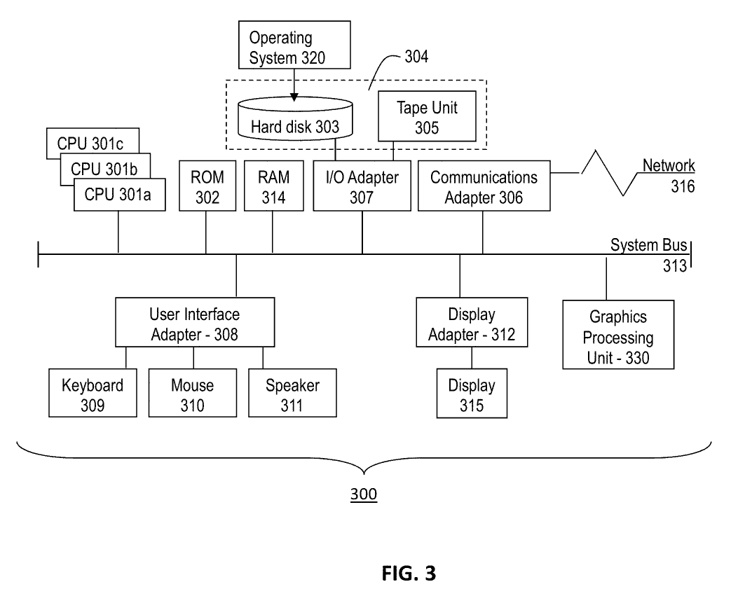

Referring to FIG. 3, there is shown a processing system 300 for implementing the teachings of the present disclosure according to one or more embodiments of the invention described herein. The system 300 has one or more central processing units (processors) 301a, 301b, 301c, etc. (collectively or generically referred to as processor(s) 301). In one embodiment, each processor 301 may include a reduced instruction set computer (RISC) microprocessor. Processors 301 are coupled to system memory 314 and various other components via a system bus 313. Read only memory (ROM) 302 is coupled to the system bus 313 and may include a basic input/output system (BIOS), which controls certain basic functions of system 300.

FIG. 3 further depicts an input/output (I/O) adapter 307 and a communications adapter 306 coupled to the system bus 313. I/O adapter 307 may be a small computer system interface (SCSI) adapter that communicates with a hard disk 303 and/or tape storage drive 305 or any other similar component. I/O adapter 307, hard disk 303, and tape storage device 305 are collectively referred to herein as mass storage 304. Operating system 320 for execution on the processing system 300 may be stored in mass storage 304. A communications adapter 306 interconnects bus 313 with an outside network 316 enabling data processing system 300 to communicate with other such systems. A screen (e.g., a display monitor) 315 is connected to system bus 313 by display adapter 312, which may include a graphics adapter to improve the performance of graphics intensive applications and a video controller. In one embodiment, adapters 307, 306, and 312 may be connected to one or more I/O busses that are connected to system bus 313 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 313 via user interface adapter 308 and display adapter 312. A keyboard 309, mouse 310, and speaker 311 all interconnect to bus 313 via user interface adapter 308, which may include, for example, a Super I/O chip integrating multiple device adapters into a single integrated circuit.

In exemplary embodiments of the invention, the processing system 300 includes a graphics-processing unit 330. Graphics processing unit 330 is a specialized electronic circuit designed to manipulate and alter memory to accelerate the creation of images in a frame buffer intended for output to a display. In general, graphics-processing unit 330 is very efficient at manipulating computer graphics and image processing, and has a highly parallel structure that makes it more effective than general-purpose CPUs for algorithms where processing of large blocks of data is done in parallel.

Thus, as configured in FIG. 3, the processing system 300 includes processing capability in the form of processors 301, storage capability including system memory 314 and mass storage 304, input means such as keyboard 309 and mouse 310, and output capability including speaker 311 and display 315. In one embodiment, a portion of system memory 314 and mass storage 304 collectively store an operating system such as the AIX® operating system from IBM Corporation to coordinate the functions of the various components shown in FIG. 3.

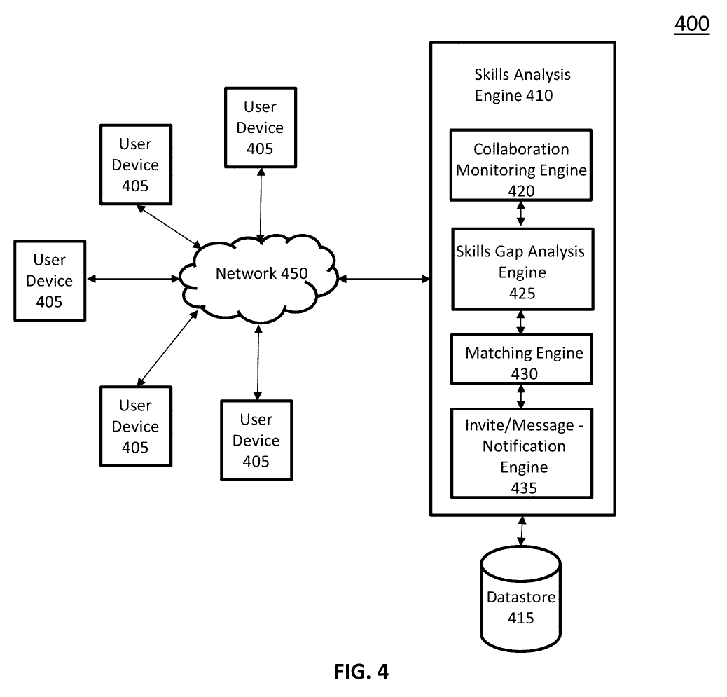

Referring now to FIG. 4, there is illustrated a computing system 400 in accordance with one or more embodiments of the invention. As illustrated, the computing system 400 can include but is not limited to, one or more user devices/clients 405, a skills analysis engine 410 and a datastore 415 connected over one or more networks, for example, network 450. The skills analysis engine 410 can include a collaboration monitoring engine 420, skills gap analysis engine 425, a matching engine 430 and an invite/message engine 435.

In some embodiments of the invention, the one or more user devices 405 can be any type of computing device, such as a computer, laptop, tablet, smartphone, wearable computing device, client, etc. Each user device 405 can include one or more applications that can communicate with the skills analysis engine 410 over one or more networks 450.

The network(s) 450 can include, but are not limited to, any one or a combination of different types of suitable communications networks such as, for example, cable networks, public networks (e.g., the Internet), private networks, wireless networks, cellular networks, or any other suitable private and/or public networks. Further, the network(s) 450 can have any suitable communication range associated therewith and can include, for example, global networks (e.g., the Internet), metropolitan area networks (MANs), wide area networks (WANs), local area networks (LANs), or personal area networks (PANs). In addition, the network(s) 450 can include any type of medium over which network traffic can be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

In some embodiments, the skills analysis engine 410 can be any type of computing device with network access, such as a computer, laptop, server, tablet, smartphone, wearable computing devices, or the like. The skills analysis engine 410 can be part of a cloud-computing environment (FIG. 1) that provides a specific functionality to the one or more user devices 405, such as a software-as-a-service functionality. The skills analysis engine 410 can be used in conjunction with a collaboration session of a collaboration platform to determine whether a gap in skills arises for users in the collaboration session in order to acquire additional resources to address the skills gap. The users can interact with the collaboration session using, for example, user device/client 405.

The collaboration monitoring engine 420 can include computer-readable instructions that, in response to execution by the processor(s) 301, cause operations to be performed including monitoring correspondence (i.e., voice, text, augmented reality interactions or other forms of communication) between users during a collaboration session. The monitoring engine 420 can monitor a discussion within the collaboration session between one or more users to determine topics, keywords and other relevant information associated with the discussion. The skills analysis engine 410 can utilize the topics, keywords and other relevant information determined by the monitoring engine 420 to determine skills indicated as needed within the collaboration session. The determined topics, keywords and other relevant information associated with the discussion can be indexed and scored as part of the determination of initial skills present and/or needed within the collaboration session. The monitoring engine 420 can also determine when skills determined may be needed within a project/collaboration lifecycle. The skills analysis engine 410 can also identify one or more skills associated with each user in the collaboration session. The monitoring engine 420 can identify keywords within the collaboration session using, for example, natural language processing. The natural language processing can be used to identify nouns and verbs within an associated discussion. The natural language processing can also be used to identify keywords associated with a particular industry, company, or group. Based on the topics, keywords and other relevant information associated with the discussion of the collaboration session, the monitoring engine 420 can determine one or more skills needed to accomplish tasks or address topics being discussed. The one or more skills can be deemed needed when terms associated with the one or more skills have been mentioned within the discussion above a predetermined threshold. The monitoring engine 420 can also facilitate a transmission of data to the datastore 415.

The skills gap analysis engine 425 may include computer-readable instructions that, in response to execution by the processor(s) 301, cause operations to be performed including determining skills that are needed to accomplish tasks discussed within the discussion but not possessed by the current users in the discussion. The skills gap analysis engine 425 can compare skills gleaned from the discussion as being needed with skills associated with all users associated with the collaboration session. One or more skills identified as being needed but are possessed by any of the current users within the collaboration session are associated with a skills gap. Accordingly, a skills gap can be determined using, for example, the following equation: Skills Gap=Skills needed to complete tasks−skills present by current users.

The matching engine 430 may include computer-readable instructions that, in response to execution by the processor(s) 301, cause operations to be performed, including matching other users associated with a collaboration platform that are not a part of the collaboration session but possess skills matching at least one of the skills associated with the skills gap. The matching engine 430 can obtain skills associated with user profiles from, for example, datastore 415 of the collaboration platform, for comparison with skills associated with the skills gap. Accordingly, the matching engine 430 can select one or more users of the collaboration platform that match skills deficient but needed in the collaboration session.

Depending on settings associated with the collaboration session, user profile information associated with the one or more users selected by the matching engine 430 can be sent to current users within the collaboration session (match notification) via invite/message—notification engine 435. A user within the collaboration session can be informed of individuals that could assist in addressing at least a portion of the skills gap via the match notification. The user can invite one or more matched users to join the collaboration session in response to the match notification. The invite/message—notification engine 435 may also send an invitation or message directly to the matched one or more users to join the collaboration session. Accordingly, skills found to be deficient (skills gap) in the collaboration session can be addressed by the one or more matched users that have joined the collaboration session.

The datastore 415 can store user profiles for each user of the collaboration platform. The datastore 415 can also store keywords and/or topics of previous collaboration sessions. The datastore 415 can receive new information about new skills to be added to one or more users, update user skills or remove skills from one or more users in a dynamic manner.

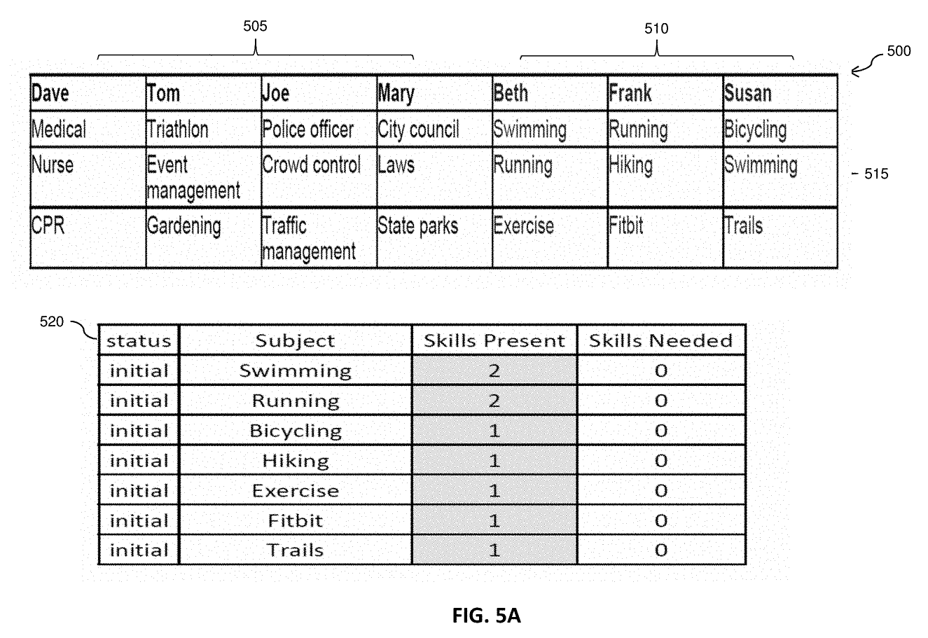

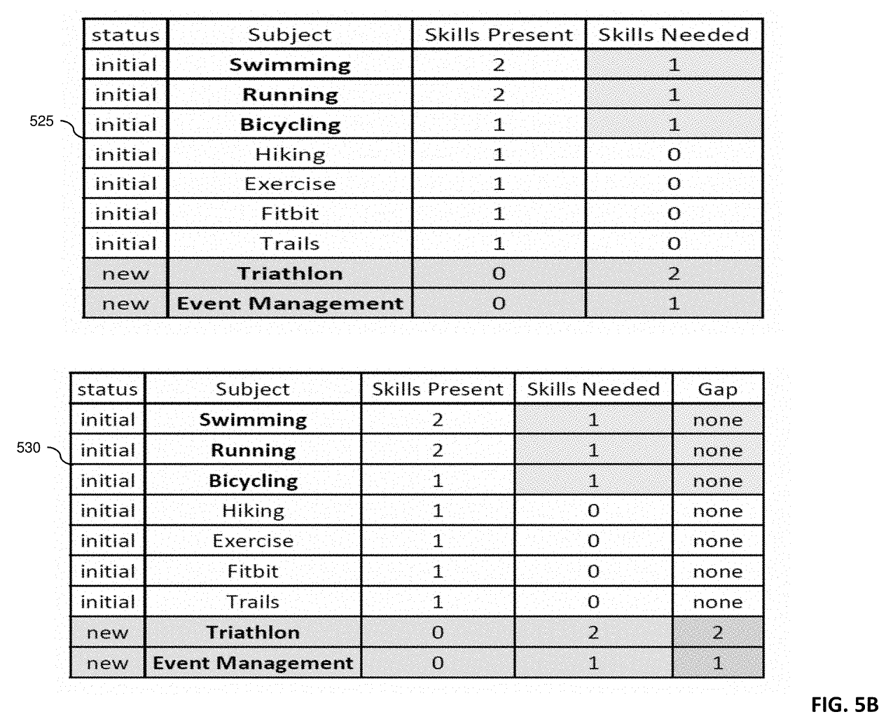

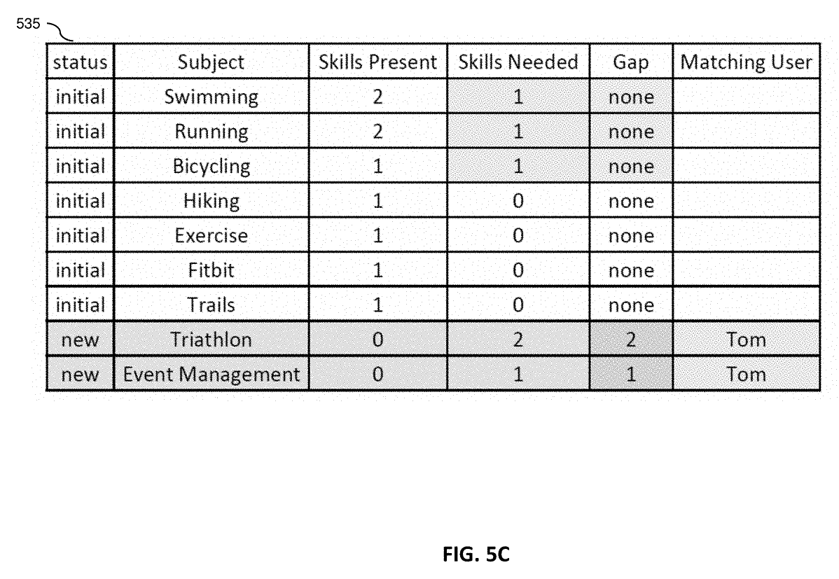

Now referring to FIGS. 5A-5C, an exemplary collaboration session in accordance with one or more embodiments of the present invention. In FIG. 5A, collaboration platform 500 comprises a plurality of user profiles indicating one or more skills 515 associated with each user. In the exemplary collaboration session, users associated with user profiles 510 can start a topic for discussion. For example, the discussion/dialogue can be related to an activity/task (e.g., organizing a triathlon). During the discussion, the users in the collaboration session can directly or indirectly indicate that additional skills/expertise are needed to accomplish the desired task, which can be determined and stored by the collaboration platform 500. For example, during the discussion, Frank can ask Beth and Susan if they have any event management experience (i.e., direct skills request). In addition, during the discussion, users can generally discuss portions of the triathlon (i.e., bike, swim and run), which the collaboration platform 500 can detect and store as skills relevant to the topic being discussed (i.e., indirect skills request).

While the collaboration session is occurring, the collaboration platform 500 can actively determine skills that may be relevant to the topic being discussed by monitoring the discussion within the collaboration session. The collaboration platform 500, can determine user skills 520 initially present at the start of the collaboration session based on, for example, the user profiles 510. During the discussion within the collaboration session, the collaboration platform 500 can monitor the discussion to glean skills that may be relevant to the topic being discussed. For example, the collaboration platform can determine keywords (nouns and/or verbs) that may be associated with a particular skill or set of skills. The collaboration platform 500 can add skills to the set of initial skills 520 to form a set of collaboration session skills 525 (FIG. 5B). The collaboration platform 500 can index the collaboration session skills 525 to determine which skills are being referenced in the discussion and how often the skills are being referenced.

The collaboration platform 500 can use the indexed collaboration session skills 525 to compare the initial skills 520 of the users to the skills being referenced in the discussion. The collaboration platform 500 can determine skills not associated with any of the users in the collaboration session that have been referenced according to the indexed collaboration session skills 525 (e.g., triathlon and event management), i.e., a skills gap. Accordingly, the collaboration platform 500 can determine skills that may be needed to complete tasks or address topics raised within the collaboration session but not possessed by current users within the collaboration session, which is indicated as skills gap 530 by the collaboration platform. The collaboration platform 500 can search the user profiles 505 of users associated with the collaboration platform 500 that are not currently a part of the ongoing triathlon collaboration session. Based on, for example, skills associated with each of the users' profiles 505, the collaboration platform 500 can determine users that possess at least one skill associated with the skills gap. For example, the collaboration platform 500 can determine that Tom possesses skills associated with the skills gap 535 (FIG. 5C).

The collaboration platform 500 can notify the users currently in the collaboration session (i.e., Frank, Beth and Susan) that a user (Tom) who is not a part of the ongoing collaboration session has skills deemed relevant to the topic and/or tasks being discussed in the collaboration session but cannot be addressed by the current users. The users in the collaboration session may send Tom an invitation to join the current collaboration session or a future collaboration session in which Tom's skills are needed. The collaboration platform 500 can also send an invitation to join the collaboration session directly to Tom. Accordingly, a skills gap within a collaboration session can determine and addressed by identifying individuals possessing the requisite skills to address the determined skills gap and allowing the individuals to join the collaboration session.

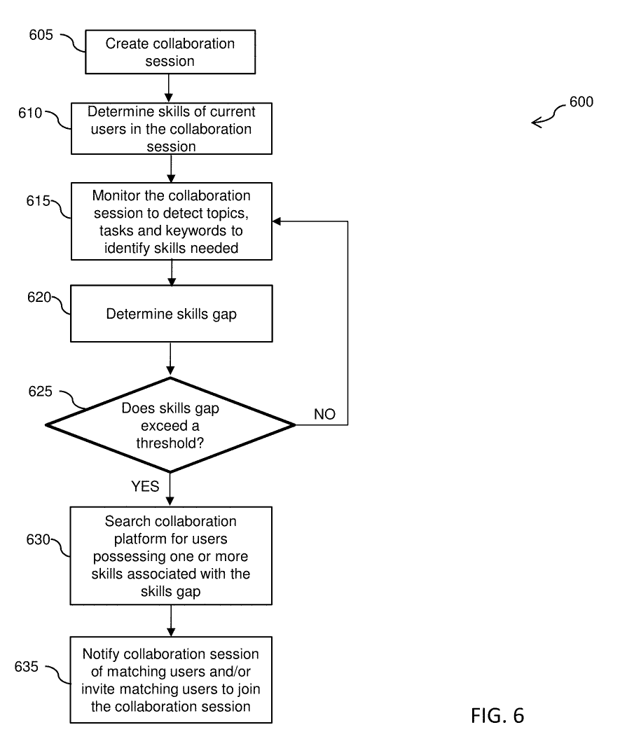

Now referring to FIG. 6, a flow diagram of a method 600 for managing a collaboration session in accordance with one or more embodiments of the present invention. At block 605, a collaboration session is created by one or more users on a collaboration platform (current users). At block 610, the collaboration platform can determine skills associated with each of the current users within the collaboration session. For example, the collaboration platform can obtain skills information for each current user from an associated user profile.

At block 615, the collaboration platform can monitor the collaboration session to detect topics and tasks being discussed within the collaboration session, as well as identify keywords within the discussion. The topics, tasks, and keywords can be used to identify skills that may be needed to address/complete the associated topics and tasks. The collaboration platform can employ natural language processing to identify the keywords. At block 620, the collaboration platform can compare the skills associated with the current users to the skills identified as needed within the collaboration session to determine a skills gap, i.e., one or more skills needed but not possessed by the current users.

At block 625, the collaboration platform can determine whether any of the skills associated with the skills gap has exceeded a threshold. For example, the threshold can be associated with a designated number of mentions for a particular skill during the collaboration session. If none of the skills associated with the skills gap exceeded the threshold, the method returns to block 615. If at least one of the skills associated with the skills gap has exceeded the threshold, the method proceeds to block 630, where the collaboration platform is searched to identify users that are not current users associated with the collaboration session but possess at least one skill associated with the skills gap. For example, the collaboration platform can compare the one or more skills associated with the skills gap to one or more user profiles of users not currently a part of the collaboration session.

At block 635, the collaboration platform can notify the current users in the collaboration session of users that possess at least one skill associated with the skills gap that may be able to assist the current users to address topics and/or tasks associated with the skills gap identified within the collaboration session. The current users can subsequently invite the users to join the collaboration session. The collaboration platform also invites/contact users that possess at least one skill associated with the skills gap to join the collaboration session directly.

Accordingly, a system, a method, and/or computer program product disclosed herein can manage a collaboration session using a collaboration platform capable of determining a skills gap during the collaboration session and inviting new users to join the collaboration session to address the deficient skills. The invitation can be based on information exchanged during the collaboration session without the users in the collaboration session actively seeking assistance from individuals to address a skills gap.

Upon sensing one or more participants being active in a collaboration session, skills associated with the one or more participants are obtained via user profiles. The application can perform a keyword analysis of an ongoing dialog within the collaboration platform. The keyword analysis can be used to understand topics and discern any skills needed for the topics. The discerned skills (skills needed) are compared with the skills associated with the one or more participants to identify any skills gaps or any duplication of skills. If a skills gap exists, the collaboration platform can examine other profiles of potential collaborators whose skills match the needed skills. The collaboration platform may also invite those whose skills match to the current collaboration. In addition, if there is a lot of skills overlap already present on the team, the collaboration platform may optimize the team by discharging team members with, for example, the least number of skills needed to address the topics.

Accordingly, one or more embodiments of the present invention can improve collaborations because a collaboration platform immediately knows skills possessed by each participant of a collaboration session. The collaboration platform can also determine and reduce skill redundancies for a team, e.g. people who have an overlap of skills within the collaboration, by removing individuals having the least amount of skills needed to address topics of the collaboration. The collaboration platform can improve chances of a successful collaboration by obtaining the right set of skills for a specific effort quickly. The collaboration platform can improve the speed at which collaborators can come to a decision or solution by obtaining the right skills needed to address a topic.

The collaboration platform can create an agile team assembly because skills for an effort are not always known at the beginning. Accordingly, the collaboration platform can provide an in situ skills gap analysis and summon matches to fill skill gaps to participate in an appropriate collaboration session taking place within a project lifecycle. The collaboration platform can focus on the skills required to solve specific problems and only invite people who are truly needed to solve the specific problems thereby freeing up other invitees when they are no longer needed.

The collaboration platform can also improve collaborations by providing a calculation of a holistic index of “skills present” based on active user keyword profiles in an active collaboration topic. The collaboration platform also provides a real-time calculation of a “skills gap” based on skills present vs needed during an active collaboration topic. The collaboration platform also provides real-time matching and recommendation of new users for the collaboration topic based on known “skills gaps” and user keyword profile. Moreover, one or more embodiments of the collaboration platform can utilize a specialized computing device that can process a large corpus of data in real-time in order to calculate a skills gap based on skills present in light of one or more participants currently in a collaboration session versus skills needed during a collaboration life cycle.

The present invention may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method for managing a collaboration session, the method comprising:
creating, using a processor, a collaboration session;
determining, using the processor, skills associated with one or more participants of the collaboration session;
monitoring, using the processor, one or more discussions within the collaboration session;
determining, using the processor and based at least in part on the monitoring, a needed skill, wherein determining the needed skill comprises determining that one or more keywords associated with the needed skill are mentioned during the one or more discussions above a predetermined threshold;
determining, using the processor, that a skills gap is present at least in part by determining that the skills associated with one or more participants do not include the needed skill;
searching, using the processor, for one or more individuals having the needed skill by comparing the needed skill to one or more user profiles of users not currently participants of the collaboration session; and
inviting, using the processor, the one or more individuals to join the collaboration session when invited by one or more participants to join the collaboration session.

2. The computer-implemented method of claim 1, further comprising determining one or more overlapping skills associated with at least two of the one or more participants.

3. The computer-implemented method of claim 2, further comprising discharging one or more participants having one or more overlapping skills.

4. The computer-implemented method of claim 1, further comprising determining one or more topics from the monitored one or more discussions within the collaboration session.

5. (canceled)

6. The computer-implemented method of claim 1, wherein the determination of the one or more keywords occurs using a natural language search.

7. (canceled)

8. A computer program product, the computer program product comprising a non-transitory computer readable storage medium having program instructions embodied therewith, the program instructions readable by a processing circuit to cause the processing circuit to:
create a collaboration session;
determine skills associated with one or more participants of the collaboration session;
monitor one or more discussions within the collaboration session;
determine, based at least in part on the monitoring, a needed skill, wherein determining the needed skill comprises determining that one or more keywords associated with the needed skill are mentioned during the one or more discussions above a predetermined threshold;
determine a that skills gap is present at least in part by determining that the skills associated with one or more participants do not include the needed skill;
search for one or more individuals having the needed skill by comparing the needed skill to one or more user profiles of users not currently participants of the collaboration session; and
invite the one or more individuals to join the collaboration session when invited by one or more participants to join the collaboration session.

9. The computer program product of claim 8, further comprising determining one or more overlapping skills associated with at least two of the one or more participants.

10. The computer program product of claim 9, further comprising discharging one or more participants having one or more overlapping skills.

11. (canceled)

12. The computer program product of claim 8, wherein the determination of the one or more keywords occurs using a natural language search.

13. (canceled)

14. The computer program product of claim 8, further comprising determining one or more topics from the monitored one or more discussions within the collaboration session.

15. A computer system, comprising:
a processor in communication with one or more types of memory, the processor configured to:
create a collaboration session;
determine skills associated with one or more participants of the collaboration session;
monitor one or more discussions within the collaboration session;
determine, based at least in part on the monitoring, a needed skill, wherein determining the needed skill comprises determining that one or more keywords associated with the needed skill are mentioned during the one or more discussions above a predetermined threshold;
determine a that skills gap is present at least in part by determining that the skills associated with one or more participants do not include the needed skill;
search for one or more individuals having the needed skill by comparing the needed skill to one or more user profiles of users not currently participants of the collaboration session; and
invite the one or more individuals to join the collaboration session when invited by one or more participants to join the collaboration session.

16. The computer system of claim 15, further comprising determining one or more overlapping skills associated with at least two of the one or more participants.

17. The computer system of claim 16, further comprising discharging one or more participants having one or more overlapping skills.

18. (canceled)

19. The computer system of claim 15, wherein the determination of the one or more keywords occurs using a natural language search.

20. (canceled)
